(19) United States
(12) Patent Application Publication
(10) Pub. No.: US 2023/0138857 A1
(43) Pub. Date: May 4, 2023

(54) Methods of Making and Using a Cementitious Composition with Ultra-Low Portland Cement

(71) Applicant: Halliburton Energy Services, Inc., Houston, TX (US)

(72) Inventors: John Paul Bir SINGH, Houston, TX (US); Thomas Jason PISKLAK, Houston, TX (US); Samuel J. LEWIS, Houston, TX (US)

(21) Appl. No.: 17/513,627

(22) Filed: Oct. 28, 2021

(51) Int. Cl. C09K 8/46; C04B 28/04; E21B 33/14

(52) U.S. Cl. CPC C09K 8/46; C04B 28/04; E21B 33/14

(57) ABSTRACT

Disclosed herein is a method of servicing a wellbore penetrating a subterranean formation, comprising: placing a cementitious composition of the type disclosed herein into the wellbore. The cementitious composition comprises a cement blend and water, wherein the cement blend comprises Portland cement and pozzolan, wherein the Portland cement is present in an amount of from equal to or greater than about 0.01 wt. % to equal to or less than about 25.0 wt. % based on the total weight of the cement blend.

### FIELD

This application relates to the recovery of natural resources from a wellbore penetrating a subterranean formation, and more specifically this application relates to cementitious compositions with ultra-low Portland cement.

### BACKGROUND

This disclosure relates generally to methods of servicing a wellbore. More specifically, it relates to methods of treating a wellbore penetrating a subterranean formation, for example during a cementing operation.

Natural resources such as gas, oil, and water residing in a subterranean formation are usually recovered by drilling a wellbore down to the subterranean formation while circulating a drilling fluid, also referred to as drilling mud, in the wellbore. After terminating circulation of the drilling fluid, a string of pipe, e.g., casing, is run in the wellbore. The drilling fluid is then usually circulated downward through the interior of the pipe and upward through the annulus, which is located between the exterior of the pipe and the walls of the wellbore. Next, primary cementing is typically performed whereby a cement slurry is placed in the annulus and permitted to set into a hard mass (i.e., sheath) to thereby attach the string of pipe to the walls of the wellbore and seal the annulus. Subsequent secondary cementing operations can also be performed. One example of a secondary cementing operation is squeeze cementing whereby a cement slurry is employed to plug and seal off undesirable flow passages in the cement sheath and/or the casing.

While cement slurries have been developed heretofore, challenges continue to exist with the successful use of cement slurries in subterranean cementing operations. The manufacture of cement is a very energy-intensive industry. Much of this energy is producing by burning fossil fuels such as coal, contributing to the production of “greenhouse gases.” One of the most discussed of these greenhouse gases is carbon dioxide (CO₂). The effect certain activities have on the climate in terms of the total amount of greenhouse gases produced is often described as a “carbon footprint.” Therefore, an ongoing need exists for a cement slurry that has low carbon footprint.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is an ultrasonic cement analyzer (UCA) chart of the three samples in accordance with some embodiments of the disclosure.

FIG. 2 illustrates surface equipment that can be used in the placement of a cementitious composition in accordance with some embodiments of the disclosure.

FIG. 3 is a depiction of the placement of a cementitious composition into a subterranean formation in accordance with some embodiments of the disclosure.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

It is to be understood that “subterranean formation” encompasses both areas below exposed earth and areas below earth covered by water such as ocean or fresh water. Herein in the disclosure, “top” means the well at the surface (e.g., at the wellhead which may be located on dry land or below water, e.g., a subsea wellhead), and the direction along a wellbore towards the well surface is referred to as “up”; “bottom” means the end of the wellbore away from the surface, and the direction along a wellbore away from the wellbore surface is referred to as “down.” For example, in a horizontal wellbore, two locations may be at the same level (i.e., depth within a subterranean formation), the location closer to the well surface (by comparing the lengths along the wellbore from the wellbore surface to the locations) is referred to as “above” the other location, the location farther away from the well surface (by comparing the lengths along the wellbore from the wellbore surface to the locations) is referred to as “below” or “lower than” the other location.

Disclosed herein is a method of servicing a wellbore penetrating a subterranean formation. In embodiments, the method comprises placing a cementitious composition into the wellbore. The cementitious composition can comprise a cement blend and water. In embodiments, the cement blend comprises Portland cement and pozzolan. The Portland cement can be present in an amount of from equal to or greater than about 0.01 wt. % to equal to or less than about 25.0 wt. % based on the total weight of the cement blend. Alternatively, the Portland cement can be present in an amount of from equal to or greater than about 0.01 wt. % to equal to or less than about 24.0 wt. %, alternatively from equal to or greater than about 0.01 wt. % to equal to or less than about 22.0 wt. %, alternatively from equal to or greater than about 0.01 wt. % to equal to or less than about 20.0 wt. %, alternatively from equal to or greater than about 0.01 wt. % to equal to or less than about 18.0 wt. %, alternatively from equal to or greater than about 0.01 wt. % to equal to or less than about 16.0 wt. %, or alternatively from equal to or greater than about 0.01 wt. % to equal to or less than about 14.0 wt. %.

Portland cements that are suited for use in the disclosed cementitious composition include, but are not limited to, Class A, C, G, H, low sulfate resistant cements, medium sulfate resistant cements, high sulfate resistant cements, or combinations thereof. The class A, C, G, and H cements are classified according to API Specification 10. Additional examples of Portland cements suitable for use in the present disclose include, without limitation, those classified as ASTM Type I, II, III, IV, or V.

Portland cement can be reactive and undergo hydration reactions to produce a hardened mass. The various oxides, such as calcium oxides, and silicates present in the Portland cement can undergo a crosslinking reaction induced by water to produce a hydrated cement paste which can then set to form the hardened mass. In embodiments, the Portland cement can include 5 main cement components. The cement components can include dicalcium silicate (C₂S), tricalcium silicate (C₃S), tricalcium aluminate (C₃A), tetra calcium alumino ferrite (C₄AF), and gypsum. As one of ordinary skill in the art will understand, each of the main cement components can hydrate at a different rate and can form different solid phases when they hydrate. Rate of hydration of each cement component in the Portland cement can be dependent on many factors such as temperature of the cement slurry.

In embodiments, the cementitious composition comprises pozzolan. The pozzolan can comprise fly ash, natural glass, volcanic glass, volcanic rock, agricultural waste ash, waste ash, ground slag, silica fume, diatomaceous earth, metakaolin, zeolite, calcined clays, shale, pumicite, tuff, cement kiln dust, granite powder, silica sand, glass beads, cenospheres, a vitrified shale, a ground pozzolanic by-product, or combinations thereof. Natural pozzolans that can be used as the pozzolan are generally present on the Earth's surface and set and harden in the presence of hydrated lime and water. In embodiments, the pozzolan comprises any type of ground pozzolanic by-products. Unlimited examples of ground pozzolanic by-products include recycled concrete dust, granite dust, and ceramic waste dust.

Pozzolan can have pozzolanic reactions upon contact with Portland cement and water. The pozzolanic reaction converts a silica-rich component (e.g., a pozzolan), to a calcium silicate, with cementitious properties. Without being limited by theory, small amounts (from equal to or greater than about 0.01 wt. % to equal to or less than about 25.0 wt. % as disclosed herein) of Portland cement can initiate the pozzolanic reaction of the pozzolan. Without being limited by theory, Portland cement can provide an alkaline environment and calcium ions to initiate and maintain the pozzolanic reaction.

In embodiments, the pozzolan is present in the cement blend in an amount of from about 75.0 wt. % to about 99.99 wt. %, based on the total weight of the cement blend, alternatively from about 78.0 wt. % to about 99.99 wt. %, alternatively from about 80.0 wt. % to about 99.99 wt. %, alternatively from about 83.0 wt. % to about 99.99 wt. %, or alternatively from about 85.0 wt. % to about 99.99 wt. %.

In embodiments, the cement blend further comprises other cementitious materials. The other cementitious material can comprise calcium, aluminum, silicon, oxygen, iron, and/or sulfur. The other cementitious material can comprise gypsum cement, shale cement, acid/base cement, phosphate cement, high alumina content cement, slag cement, silica cement, high alkalinity cement, magnesia cement, other settable materials, or combinations thereof. In embodiments, “high alumina content cement” refers to a cement having an alumina concentration in the range of from about 40 wt. % to about 80 wt. % by a weight of the high alumina content cement. In embodiments, “high alkalinity cement” refers to a cement having a sodium oxide concentration in the range of from about 1.0 wt. % to about 2.0 wt. % by a weight of the high alkalinity cement. Shale cement refers to a supplementary cementitious material made from ground and burned shale. Silica cement can be formed when phosphoric acid displaces metal ions from an alumina-silica glass, containing metal oxides and fluorides.

The cement blend can be present in the cementitious composition in an amount of from about 0.001 wt. % to about 85.0 wt. % based on the total weight of the cementitious composition, alternatively from about 0.01 wt. % to about 75.0 wt. %, alternatively from about 1 wt. % to about 75.0 wt. %, or alternatively from about 5 wt. % to about 75.0 wt. %.

The cementitious composition can comprise water. Generally, the water may be from any source, provided that it does not contain an amount of components that may undesirably affect the other components in the cementitious composition. For example, the water can be selected from a group consisting essentially of fresh water, surface water, ground water, produced water, sea water, salt water, brine (e.g., underground natural brine, formulated brine, etc.), and combinations thereof. A formulated brine may be produced by dissolving one or more soluble salts in water, a natural brine, or sea water. Representative soluble salts include the chloride, bromide, acetate, and formate salts of potassium, sodium, calcium, magnesium, and zinc. The water can be present in the cementitious composition in an amount effective to provide a slurry having desired (e.g., job or service specific) rheological properties. In embodiments, the water is present in the cementitious composition in an amount of from about 20% by weight of blend (bwob) to about 200% bwob based on the total weight of the cement blend, alternatively from about 40% bwob to about 200% bwob, or alternatively from about 60% bwob to about 200% bwob.

In embodiments, the cementitious composition further comprises one or more additives. The one or more additives can comprise weighting agents, retarders, accelerators, activators, gas control additives, lightweight additives, gas-generating additives, mechanical-property-enhancing additives (e.g., carbon fibers, glass fibers, metal fibers, minerals fibers, polymeric elastomers, latexes, etc.), lost-circulation materials, filtration-control additives, fluid-loss-control additives, defoaming agents, foaming agents, transition time modifiers, dispersants, thixotropic additives, suspending agents, or combinations thereof. One having ordinary skill in the art, with the benefit of this disclosure, should be able to select one or more appropriate additives for a particular application.

In embodiments, the one or more additives are present in the cementitious composition in an amount of from about 0.05% bwob to about 50% bwob based on the total weight of the cement blend, alternatively from about 0.1% bwob to about 50% bwob, or alternatively from about 0.1% bwob to about 45% bwob.

In embodiments, the cementitious composition has a thickening time. The thickening time herein refers to the time required for the cementitious composition to achieve 70 Bearden units of Consistency (Bc) after preparation of the cementitious composition. At about 70 Bc, the cementitious composition undergoes a conversion from a pumpable fluid state to a non-pumpable gel. The thickening time can be an important design factor as the cementitious composition may be pumped thousands of meters through conduit and may take hours to place. In order to keep the cementitious composition in a pumpable state for the appropriate amount of time, cement additives such as retarders and accelerators can be added to modulate the pump time by shortening or extending the thickening time. A measurement of Bearden units of Consistency (Bc) can be considered a thickening time test which is performed on a moving fluid. In a thickening time test, an apparatus including a pressurized consistometer can apply temperature and pressure to a slurry (e.g., a cementitious composition) while the slurry is being stirred by a paddle. A resistor arm and potentiometer coupled to the paddle can provide an output in units of Beardan units of consistency.

In embodiments, the thickening time of the cementitious composition increases as the amount of the Portland cement in the cementitious composition increases. In other words, besides providing an alkaline environment and calcium ions for the pozzolanic reaction, small amounts (from equal to or greater than about 0.01 wt. % to equal to or less than about 25.0 wt. % as disclosed herein) of Portland cement can retard setting time of the cementitious composition at the same time.

In embodiments, the cementitious composition has a thickening time to reach about 70 Bc in a range of from about 2.0 hours to about 20.0 hours at about 160° F., alternatively from about 3.0 hours to about 18.0 hours, alternatively from about 4.0 hours to about 15.0 hours, alternatively from about 5.0 hours to about 15.0 hours, when measured in accordance with test standard API-RP-10B-2.

Compressive strength is generally the capacity of a material or structure to withstand axially directed pushing forces. The compressive strength of a cementitious composition can be measured at a specified time (e.g., 24 hours) after a cement blend has been mixed with water and the resultant cement slurry is maintained under specified temperature and pressure conditions to form a hardened, set cement. For example, compressive strength can be measured at a time in the range of from about 24 to about 48 hours (or longer) after the cement slurry is mixed, and the cement slurry is maintained at a temperature of from 100° F. to about 200° F. and atmospheric pressure, during which time the cement slurry can set into a hardened mass. Compressive strength can be measured by either a destructive method or non-destructive method. The destructive method physically tests the strength of treatment fluid samples at various points in time by crushing the samples in a compression-testing machine. The compressive strength is calculated from the failure load divided by the cross-sectional area resisting the load and is reported in units of pound-force per square inch (psi). Non-destructive methods can employ an ultrasonic cement analyzer (UCA). A UCA can be available from Fann® Instrument Company, Houston, Tex. Compressive strengths can be determined in accordance with API RP 10B-2, Recommended Practice for Testing Well Cements, First Edition, July 2005.

In embodiments, the cementitious composition has a compressive strength measured in accordance with test standard API-RP-10B-2. The compressive strength can be in a range of from about 50.0 psi to about 10,000.0 psi at about 160° F. between about 24 hours to about 48 hours in a UCA test, alternatively from about 100.0 psi to about 10,000.0 psi, alternatively from about 200.0 psi to about 7,500.0 psi, alternatively from about 250.0 psi to about 5,500.0 psi, alternatively from about 300.0 psi to about 3,500.0 psi, alternatively from about 300.0 psi to about 2,500.0 psi, or alternatively from about 300.0 psi to about 1,500.0 psi. The time is 24 to 48-hour period after mixing the cement blend with water.

In embodiments, the cementitious composition has a time to reach 50 psi (345 kPa) compressive strength (also referred to as “time to reach 50 psi”) measured in an ultrasonic cement analyzer (UCA) test in accordance with test standard API-RP-10B-2. The time to reach 50 psi under static conditions in a UCA can be used as an estimation of the initial set time of a cementitious composition. The time to reach 50 psi can be the time it takes for a cement slurry to transition from a pumpable fluid state to a hardened set state. In embodiments, the time to reach 50 psi compressive strength of the cementitious composition increases as the amount of the Portland cement increases. Without being limited by theory, this is because small amounts of Portland cement as disclosed herein can retard setting time of the cementitious composition.

In embodiments, the cementitious composition has a time to reach 50 psi compressive strength in a range of from about 2.0 hours to about 20.0 hours at about 160° F. in a UCA test, alternatively from about 4.0 hours to about 20.0 hours, alternatively from about 5.0 hours to about 20.0 hours, alternatively from about 6.0 hours to about 20.0 hours, alternatively from about 8.0 hours to about 20.0 hours, or alternatively from about 10.0 hours to about 20.0 hours, when measured in accordance with test standard API-RP-10B-2.

In embodiments, the cementitious compositions disclosed herein advantageously are characterized by a binary thickening time behavior x where at equal to or less than about 25 wt. % Portland cement, x increases with increasing amounts of Portland cement. However, at greater than 25 wt. % Portland cement x decreases with increasing amounts of Portland cement. In such embodiments, the compressive strength of the cementitious composition correlates directly with the Portland cement concentration such that increasing amounts of Portland cement result in an increase in compressive strength.

Graphically a plot of the relationship between compressive strength and Portland cement content would be expected to be monotonically increasing with increasing amounts of Portland cement where increasing concentrations of Portland cement result in increasing a compressive strength of the set cement. In sharp contrast, a plot of thickening time of the compositions disclosed herein as a function of the amount of Portland cement would show an increase in thickening time with increasing Portland cement amounts until the amount ranged from about 22 wt. % to about 28 wt. %, alternatively from about 23 wt. % to about 27 wt. % or alternatively at about 25 wt. %. At greater than about 25 wt. % an inflection point in a graph of the thickening time as a function of Portland cement content would be observed and the thickening time would then increase with increasing amounts of Portland cement. This is a surprisingly unexpected result as conventional cement compositions display monotonically increasing thickening time with an increase in the amount of Portland cement hus these materials lack an inflection point in a plot of thickening time as a function of the amount of Portland cement.

The cementitious composition disclosed herein can have any suitable viscosity. In embodiments, the cementitious composition has a viscosity in a range of from about 3.0 cp to about 2,500.0 cp, alternatively from about 5.0 cp to about 2,500.0 cp, alternatively from about 8.0 cp to about 1,500.0 cp, or alternatively from about 10.0 cp to about 1,500.0 cp, when measured in accordance with test standard API-RP-10B-2. A Couette type rotational viscometer (e.g., Fann Model 35) can be used for the measurement.

The cementitious composition disclosed herein can have any suitable density, including, but not limited to, in a range of from about 4.0 lb/gal (ppg) to about 25.0 ppg, alternatively from about 7.0 ppg to about 23.0 ppg, alternatively from about 10.0 ppg to about 23.0 ppg, alternatively from about 10.0 ppg to about 22.0 ppg. or alternatively from about 11.0 ppg to about 20.0 ppg.

In embodiments, the cementitious composition has a carbon footprint of equal to or less than about 150.0 kilograms of equivalent CO₂ per barrel of the cementitious composition (kg/bbl), alternatively equal to or less than about 120.0 kg/bbl, alternatively equal to or less than about 100.0 kg/bbl, alternatively equal to or less than about 80.0 kg/bbl, alternatively equal to or less than about 70.0 kg/bbl, alternatively equal to or less than about 65.0 kg/bbl, alternatively equal to or less than about 60.0 kg/bbl, or alternatively equal to or less than about 50.0 kg/bbl.

Carbon footprint, which refers to carbon emissions due to a material, can be determined by a cradle to grave lifecycle analysis of the material. Cradle to grave includes emissions related to production, transportation, storage, usage and disposal stages of a material. Total emissions associated with a material is the sum of emissions in each phase. Emissions can be expressed as kilograms of equivalent CO₂ per unit mass (or volume) of the material. There are several standards for computing the carbon emissions of a material. For example, the United States Environmental Protection Agency (EPA) publishes standards listed in the EPA's Waste Reduction Model (WARM) which allows for calculation of the carbon emissions of a material. Another source of standard is the California Air Resources Board's green house gas quantification methodology. The present disclosure uses data from the Inventory of Carbon & Energy (ICE) Version 2.0 by G. Hammond and C. Jones, 2011 (last accessed on Oct. 4, 2021 at http://carbonsolutions.com/Resources/ICE %20V2.0%20-%20Jan%202011. xls) for calculating carbon footprint for materials. The carbon footprint of a cementitious composition is calculated using Equation (1) as below:

Carbon footprint=Σₖ₌₁ⁿ(carbon footprint)ₖ·xₖ (1)

wherein the cementitious composition comprises n components, wherein (carbon footprint)ₖ is the carbon footprint of pure component k, and xₖ is the concentration of component k in the cementitious composition.

In some embodiments, the cementitious composition is used at temperature in a range of from about 50° F. to about 400° F., alternatively from about 50° F. to about 375° F., alternatively from about 50° F. to about 350° F., alternatively from about 50° F. to about 325° F., or alternatively from about 50° F. to about 300° F.

A cementitious composition of the type disclosed herein can be prepared using any suitable method. In embodiments, the method comprises mixing components (e.g., Portland cement, pozzolan, water) of the cementitious composition using mixing equipment (e.g., a mixer, a blender, a mixing head of a solid feeding system). Mixing the components of the cementitious composition can comprise one or more steps. For example, mixing the components of the cementitious composition can comprise dry mixing components of the cement blend and optional other solid components (e.g., a weighting agent) to form a dry mixture, and mixing the dry mixture with water and optional other additives to form a pumpable slurry (e.g., a homogeneous fluid). Any container(s) that is compatible with the components and has sufficient space can be used for mixing.

In embodiments, mixing the components of the cementitious composition can be on-the-fly (e.g., in real time or on-location) at a wellsite. For example, the components of the cement blend (e.g., Portland cement, pozzolan) can be transported to the wellsite and combined (e.g., mixed/blended) with water located proximate the wellsite to form the cementitious composition. The water can be conveyed from a source to the wellsite or be available at the wellsite prior to the combining. The cement blend can be prepared at a location remote from the wellsite and transported to the wellsite, and, if necessary, stored at the on-site location. When it is desirable to prepare the cementitious composition at the wellsite, the components of the cement blend along with additional water and optional other additives can be mixed to form a mixture (e.g. in a blender tub, for example mounted on a trailer). Additives can be added to the cementitious composition during preparation thereof (e.g., during mixing) and/or on-the-fly (e.g., in real time or on-location) by addition to (e.g., injection into) the cementitious composition when being pumped into the wellbore.

The method disclosed herein can further comprise introducing the cementitious composition into a subterranean formation, and allowing at least a portion of the cementitious composition to set. In embodiments, introducing the cementitious composition into the subterranean formation uses one or more pumps.

A cementitious composition of the type disclosed herein can be used as a cementitious fluid. A cementitious fluid refers to a material that can set and be used to permanently seal an annular space between casing and a wellbore wall. A cementitious fluid can also be used to seal formations to prevent loss of drilling fluid (e.g., in squeeze cementing operations) and for operations ranging from setting kick-off plugs to plug and abandonment of a wellbore. Generally, a cementitious fluid used in oil field is pumpable in relatively narrow annulus over long distances. Disclosed herein is a method of servicing a wellbore penetrating a subterranean formation. In embodiments, the method comprises placing a cementitious composition into the wellbore.

In embodiments, the cementitious composition is used in a subterranean workspace, for example in cementing underground pipe such as sewer pipe or wellbore casing. In embodiments, the cementitious composition is employed in primary cementing of a wellbore for the recovery of natural resources such as water or hydrocarbons. Primary cementing first involves drilling a wellbore to a desired depth such that the wellbore penetrates a subterranean formation while circulating a drilling fluid through the wellbore. Subsequent to drilling the wellbore, at least one conduit such as a casing can be placed in the wellbore while leaving a space known as the annulus (i.e., annular space) between the wall of the conduit and the wall of the wellbore. The drilling fluid can then be displaced down through the conduit and up through the annulus one or more times, for example, twice, to clean out the hole. The cementitious composition can then be conveyed (e.g., pumped) downhole and up through the annulus, thereby displacing the drilling fluid from the wellbore. In embodiments, the cementitious composition sets into a hard mass, which forms a cement column that isolates an adjacent portion of the subterranean formation and provides support to the adjacent conduit.

In some other embodiments, the cementitious composition is employed in a secondary cementing operation such as squeeze cementing, which is performed after the primary cementing operation. In squeeze cementing, the cementitious composition can be forced under pressure into permeable zones through which fluid can undesirably migrate in the wellbore. Examples of such permeable zones include fissures, cracks, fractures, streaks, flow channels, voids, high permeability streaks, annular voids, or combinations thereof. The permeable zones can be present in the cement column residing in the annulus, a wall of the conduit in the wellbore, a microannulus between the cement column and the subterranean formation, and/or a microannulus between the cement column and the conduit. The cementitious composition can set within the permeable zones, thereby forming a hard mass to plug those zones and prevent fluid from leaking therethrough.

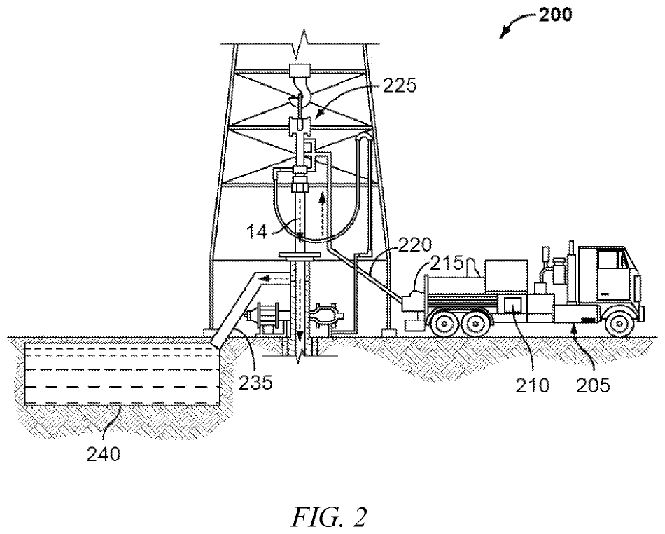

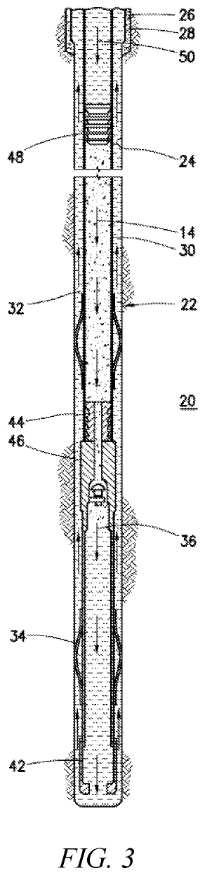

An example primary cementing technique using a cementitious composition will now be described with reference to FIGS. 2 and 3. FIG. 2 illustrates surface equipment 200 that can be used in the placement of a cementitious composition in accordance with certain examples. It will be noted that while FIG. 2 generally depicts a land-based operation, those skilled in the art will readily recognize that the principles described herein are equally applicable to subsea operations that employ floating or sea-based platforms and rigs, without departing from the scope of the disclosure. As illustrated by FIG. 2, the surface equipment 200 can include a cementing unit 205, which can include one or more cement trucks. The cementing unit 205 can include mixing equipment 210 and pumping equipment 210 as will be apparent to those of ordinary skill in the art. Cementing unit 205, or multiple cementing units 205, can pump a cementitious composition 14 of the type disclosed herein through a feed pipe 220 and to a cementing head 225 which conveys the cementitious composition 14 downhole. Cementitious composition 14 can displace other fluids present in the wellbore, such as drilling fluids and spacer fluids, which can exit the wellbore through an annulus and flow through pipe 235 to mud pit 240.

Referring to FIG. 3, the cementitious composition 14 can be placed into a subterranean formation 20 in accordance with example embodiments. As illustrated, a wellbore 22 can be drilled into the subterranean formation 20. While wellbore 22 is shown extending generally vertically into the subterranean formation 20, the principles described herein are also applicable to wellbores that extend at an angle through the subterranean formation 20, such as horizontal and slanted wellbores. As illustrated, the wellbore 22 comprises walls 24 of the wellbore 22. In the illustrated embodiment, a surface casing 26 has been inserted into the wellbore 22. The surface casing 26 can be cemented to the walls 24 of the wellbore 22 by cement sheath 28. In the illustrated embodiment, one or more additional conduits (e.g., intermediate casing, production casing, liners, etc.), shown here as casing 30 can also be disposed in the wellbore 22. As illustrated, there is a wellbore annulus (i.e., annular space) 32 formed between the casing 30 and the walls 24 of the wellbore 22 and/or the surface casing 26. One or more centralizers 34 can be attached to the casing 30, for example, to centralize the casing 30 in the wellbore 22 prior to and during the cementing operation.

With continued reference to FIG. 3, the cementitious composition 14 can be placed (e.g., pumped) down the interior of the casing 30. The cementitious composition 14 can be allowed to flow down the interior of the casing 30 through the casing shoe 42 at the bottom of the casing 30 and up around the casing 30 into the wellbore annulus 32. The cementitious composition 14 can be allowed to set in the wellbore annulus 32, for example, to form a cement sheath that supports and positions the casing 30 in the wellbore 22. Other techniques can also be utilized for introduction of the cementitious composition 14. By way of example, reverse circulation techniques can be used that includes introducing the cementitious composition 14 into the subterranean formation 20 by way of the wellbore annulus 32 instead of through the casing 30. In such embodiments, the method comprises circulating the cementitious composition 14 down through the wellbore annulus 32 and back up through the interior of the casing 30.

In embodiments, the cementitious composition 14 displaces other fluids 36, such as drilling fluids and/or spacer fluids that can be present in the interior of the casing 30 and/or the wellbore annulus 32. At least a portion of the displaced fluids 36 can exit the wellbore annulus 32 via a flow line and be deposited, for example, in one or more retention pits (e.g., a mud pit 240 in FIG. 2). A bottom plug 44 can be introduced into the wellbore 22 ahead of the cementitious composition 14, for example, to separate the cementitious composition 14 from the fluids 36 that can be inside the casing 30 prior to cementing. After the bottom plug 44 reaches the landing collar 46, a diaphragm or other suitable device can rupture to allow the cementitious composition 14 through the bottom plug 44. In FIG. 3, the bottom plug 44 is shown on the landing collar 46. In the illustrated embodiment, a top plug 48 can be introduced into the wellbore 22 behind the cementitious composition 14. The top plug 48 can separate the cementitious composition 14 from a displacement fluid 50 and also push the cementitious composition 14 through the bottom plug 44.

In embodiments, the method disclosed herein further comprises circulating the cementitious composition down through a conduit (e.g., casing) and back up through an annular space (also referred to as an annulus or a wellbore annulus) between an outside wall of the conduit and a wall of the wellbore. In some other embodiments, the method disclosed herein further comprises circulating the cementitious composition down through an annular space between an outside wall of a conduit and a wall of the wellbore and back up through the conduit. The method can further comprise allowing at least a portion of the cementitious composition to set.

Disclosed herein is a method of servicing a wellbore penetrating a subterranean formation. The method can comprise placing a cementitious composition of the type disclosed herein into the wellbore, and allowing at least a portion of the cementitious composition to set. Also disclosed herein is a method of servicing a wellbore with a conduit (e.g., casing, production tubing, tubular, or other mechanical conveyance, etc.) disposed therein to form an annular space between a wellbore wall and an outer surface of the conduit. In embodiments, the method comprises placing a cementitious composition of the type disclosed herein into at least a portion of the annular space, and allowing at least a portion of the cementitious composition to set.

In the method disclosed herein, placing a cementitious composition into at least a portion of the annular space can be in different directions. In some embodiments, placing the cementitious composition comprises circulating the cementitious composition down through the conduit and back up through the annular space. In some other embodiments, placing the cementitious composition comprises circulating the cementitious composition down through the annular space and back up through the conduit. In embodiments, the conduit comprises casing.

Various benefits may be realized by utilization of the presently disclosed methods and compositions. By incorporating into the cementitious composition a small amount (from equal to or greater than about 0.01 wt. % to equal to or less than about 25.0 wt. % as disclosed herein) of Portland cement, the carbon footprint of the cementitious composition can be reduced. The small amount of Portland cement can initiate the pozzolanic reaction and retard setting time of the cementitious composition at the same time.

### EXAMPLES

The embodiments having been generally described, the following examples are given as particular embodiments of the disclosure and to demonstrate the practice and advantages thereof. It is understood that the examples are given by way of illustration and are not intended to limit the specification or the claims in any manner.

### Example 1

Three cement compositions were formulated with the same loading of additives and increasing concentrations of Portland cement: 4 vol. %, 8 vol. %, and 12 vol. %, respectively, based on the total volume of the cement blend. Each of the cement composition was prepared following API specifications. Composition of the three cement compositions are shown in Table 1.

TABLE 1
Composition of the cement compositions

| | | | | |
|---|---|---|---|---|
| | | 4% Portland | 8% Portland | 12% Portland |
| Material | Units | design | design | design |

Bulk blend

| | | | | |
|---|---|---|---|---|
| Portland cement | % Vol | 4 | 8 | 12 |
| Pozzolan | % Vol | 96 | 92 | 88 |

Additives

| | | | | |
|---|---|---|---|---|
| Fluid loss | % bwob | 0.21 | 0.21 | 0.21 |
| additive | | | | |
| Cement retarder | % bwob | 0.4 | 0.4 | 0.4 |
| Suspending aid | % bwob | 0.08 | 0.08 | 0.08 |
| Accelerator | % bwob | 2.7 | 2.7 | 2.7 |
| Water | gal/sack | 5.2 | 5.2 | 4.7 |
| Slurry density | ppg | 13.2 | 13.2 | 13.2 |

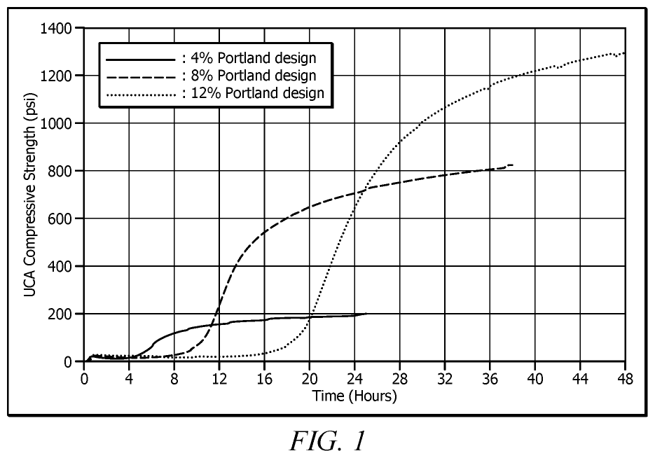

Each of the cement composition was loaded into an ultrasonic cement analyzer (UCA) to measure compressive strength development and into a consistometer to measure thickening time. The test conditions and results are shown in Table 2 and FIG. 1.

TABLE 2
Summary of test conditions and results for the cement compositions

| | Slurry | | | Thickening | UCA, time to | Ultimate |
|---|---|---|---|---|---|---|
| Cement | density | BHST | BHCT | time to | reach 50 psi | compressive |
| composition | (ppg) | (° F.) | (° F.) | 70 Bc (hh:mm) | (hrs) | strength (psi) |
| 4% Portland | 13.2 | 160 | 160 | ~2:00 | 5.67 | 201 |
| design | | | | | | |
| 8% Portland | 13.2 | 160 | 160 | 3:05 | 9.55 | 826 |
| design | | | | | | |
| 12% Portland | 13.2 | 160 | 160 | 6:44 | 17.21 | 1298 |
| design | | | | | | |

As shown in Table 2, both thickening time and time to reach 50 psi increase with increasing concentration of Portland cement, which is an unexpected result. Ultimate compressive strength (UCS) increases as the concentration of Portland cement increases. Utilizing these properties of the cement compositions of the type disclosed herein will allow for the use of Portland cement as both the alkaline source to initiate and sustain the pozzolanic reaction (as shown by UCS) and as a set control agent (as demonstrated by set time and thickening time results).

### Example 2

Portland cement is one of the highest carbon emission factor materials with a value of around 950 kg CO₂/tonne of material. Therefore, reducing Portland cement in a cement slurry can reduce the carbon footprint of the cement slurry. The cementitious compositions of the type disclosed herein have reduced carbon footprints compared with conventional cement slurries, as shown in Table 3 below. Carbon footprint is in a unit of equivalent CO₂ per barrel of the cementitious composition (kg/bbl) calculated using Equation (1) with data from the Inventory of Carbon & Energy (ICE) Version 2.0 (G. Hammond and C. Jones, 2011).

TABLE 3
Formulation of the cement compositions

| | | | | | | |
|---|---|---|---|---|---|---|
| | | | Lowered | 4% | 8% | 12% |
| | | Conventional | Portland design | Portland | Portland | Portland |
| Material | Units | slurry design | (Conventional) | design | design | design |

Bulk blend

| | | | | | | |
|---|---|---|---|---|---|---|
| Portland | % Vol (of the | 100 | 45 | 4 | 8 | 12 |
| cement | bulk blend) | | | | | |
| Pozzolan | % Vol (of the | — | 55 | 96 | 92 | 88 |
| | bulk blend) | | | | | |

Additives

| | | | | | | |
|---|---|---|---|---|---|---|
| Fluid loss | % bwob | 0.30 | 0.30 | 0.21 | 0.21 | 0.21 |
| additive | | | | | | |
| Cement | % bwob | 0.25 | 0.25 | 0.4 | 0.4 | 0.4 |
| retarder | | | | | | |
| Suspending | % bwob | 0.05 | 0.05 | 0.08 | 0.08 | 0.08 |
| aid | | | | | | |
| Accelerator | % bwob | 1.0 | 1.0 | 2.7 | 2.7 | 2.7 |
| Water | gal/sack | | | 5.2 | 5.2 | 4.7 |
| Slurry density | ppg | 13.2 | 13.2 | 13.2 | 13.2 | 13.2 |

Carbon footprint

| | | | | | |
|---|---|---|---|---|---|
| CO₂ e[kg/bbl] | 130.9 | 76.2 | 16.1 | 23.9 | 31.2 |

### Additional Disclosure

The following is provided as additional disclosure for combinations of features and embodiments of the present disclosure.

A first embodiment, which is a method of servicing a wellbore penetrating a subterranean formation, comprising: placing a cementitious composition into the wellbore, wherein the cementitious composition comprises a cement blend and water, wherein the cement blend comprises Portland cement and pozzolan, wherein the Portland cement is present in an amount of from equal to or greater than about 0.01 wt. % to equal to or less than about 25.0 wt. % based on the total weight of the cement blend.

A second embodiment, which is the method of the first embodiment, wherein the pozzolan comprises fly ash, natural glass, volcanic glass, volcanic rock, agricultural waste ash, waste ash, ground slag, silica fume, diatomaceous earth, metakaolin, zeolite, calcined clays, shale, pumicite, tuff, cement kiln dust, granite powder, silica sand, glass beads, cenospheres, a vitrified shale, a ground pozzolanic by-product, or combinations thereof.

A third embodiment, which is the method of the first or the second embodiment, wherein the pozzolan is present in the cement blend in an amount of from about 75.0 wt. % to about 99.99 wt. %, based on the total weight of the cement blend.

A fourth embodiment, which is the method of any of the first through the third embodiments, wherein the cement blend further comprises gypsum cement, shale cement, acid/base cement, phosphate cement, high alumina content cement, slag cement, silica cement, high alkalinity cement, magnesia cement, other settable materials, or combinations thereof.

A fifth embodiment, which is the method of any of the first through the fourth embodiments, wherein the cement blend is present in the cementitious composition in an amount of from about 0.001 wt. % to about 85.0 wt. % based on the total weight of the cementitious composition.

A sixth embodiment, which is the method of any of the first through the fifth embodiments, wherein the water comprises fresh water, surface water, ground water, produced water, salt water, sea water, brine, or combinations thereof.

A seventh embodiment, which is the method of any of the first through the sixth embodiments, wherein the water is present in the cementitious composition in an amount of from about 20% bwob to about 200% bwob based on the total weight of the cement blend.

An eighth embodiment, which is the method of any of the first through the seventh embodiments, wherein the cementitious composition further comprises one or more additives.

A ninth embodiment, which is the method of the eighth embodiment, wherein the one or more additives comprise weighting agents, retarders, accelerators, activators, gas control additives, lightweight additives, gas-generating additives, mechanical-property-enhancing additives, lost-circulation materials, filtration-control additives, fluid-loss-control additives, defoaming agents, foaming agents, transition time modifiers, dispersants, thixotropic additives, suspending agents, or combinations thereof.

A tenth embodiment, which is the method of the eighth embodiment or the ninth embodiment, wherein the one or more additives are present in the cementitious composition in an amount of from about 0.05% bwob to about 50% bwob based on the total weight of the cement blend.

An eleventh embodiment, which is the method of any of the first through the tenth embodiments, wherein a thickening time of the cementitious composition increases as the amount of the Portland cement increases.

A twelfth embodiment, which is the method of any of the first through the eleventh embodiments, wherein the cementitious composition has a thickening time to reach about 70 Bearden units of consistency (Bc) in a range of from about 2.0 hours to about 20.0 hours at about 160° F., when measured in accordance with test standard API-RP-10B-2.

A thirteenth embodiment, which is the method of any of the first through the twelfth embodiments, wherein a time to reach 50 psi compressive strength of the cementitious composition increases as the amount of the Portland cement increases, wherein the time to reach 50 psi compressive strength is measured in an ultrasonic cement analyzer (UCA) test in accordance with test standard API-RP-10B-2.

A fourteenth embodiment, which is the method of any of the first through the thirteenth embodiments, wherein the cementitious composition has a time to reach 50 psi compressive strength in a range of from about 2.0 hours to about 20.0 hours at about 160° F. in a UCA test, when measured in accordance with test standard API-RP-10B-2.

A fifteenth embodiment, which is the method of any of the first through the fourteenth embodiments, wherein the cementitious composition has a UCA compressive strength in a range of from about 50.0 psi to about 10,000.0 psi at about 160° F. between about 24 hours to about 48 hours in a UCA test when measured in accordance with test standard API-RP-10B-2.

A sixteenth embodiment, which is the method of any of the first through the fifteenth embodiments, wherein the cementitious composition has a viscosity of from about 3.0 cP to about 2500.0 cP.

A seventeenth embodiment, which is the method of any of the first through the sixteenth embodiments, wherein the cementitious composition has a density of from about 4.0 lb/gal to about 25.0 lb/gal.

An eighteenth embodiment, which is the method of any of the first through the seventeenth embodiments, wherein the cementitious composition has a carbon footprint of equal to or less than about 150.0 kilograms of equivalent CO₂ per barrel of the cementitious composition (kg/bbl).

A nineteenth embodiment, which is a method of preparing a cementitious composition, comprising: mixing components of the cementitious composition using mixing equipment, wherein the cementitious composition comprises a cement blend and water, wherein the cement blend comprises Portland cement and pozzolan, wherein the Portland cement is present in an amount of from equal to or greater than about 0.01 wt. % to equal to or less than about 25.0 wt. % based on the total weight of the cement blend.

A twentieth embodiment, which is the method of the nineteenth embodiment, further comprising introducing the cementitious composition into a subterranean formation, and allowing at least a portion of the cementitious composition to set.

A twenty-first embodiment, which is the method of the twentieth embodiment, wherein introducing the cementitious composition into the subterranean formation uses one or more pumps.

A twenty-second embodiment, which is the method of any of the first through the eighteenth embodiments, further comprising circulating the cementitious composition down through a conduit and back up through an annular space between an outside wall of the conduit and a wall of the wellbore.

A twenty-third embodiment, which is the method of any of the first through the eighteenth embodiments, further comprising circulating the cementitious composition down through an annular space between an outside wall of a conduit and a wall of the wellbore and back up through the conduit.

A twenty-fourth embodiment, which is the method of any of the first through the eighteenth, the twenty-second, and the twenty-third embodiments, further comprising allowing at least a portion of the cementitious composition to set.

A twenty-fifth embodiment, which is a method of servicing a wellbore penetrating a subterranean formation, comprising: placing a cementitious composition into the wellbore, wherein the cementitious composition comprises a cement blend and water, wherein the cement blend comprises Portland cement and pozzolan, wherein the Portland cement is present in an amount of from equal to or greater than about 0.01 wt. % to equal to or less than about 25.0 wt. % based on the total weight of the cement blend; and allowing at least a portion of the cementitious composition to set.

A twenty-sixth embodiment, which is a method of servicing a wellbore with a conduit disposed therein to form an annular space between a wellbore wall and an outer surface of the conduit, comprising: placing a cementitious composition into at least a portion of the annular space, wherein the cementitious composition a cement blend and water, wherein the cement blend comprises Portland cement and pozzolan, wherein the Portland cement is present in an amount of from equal to or greater than about 0.01 wt. % to equal to or less than about 25.0 wt. % based on the total weight of the cement blend; and allowing at least a portion of the cementitious composition to set.

A twenty-seventh embodiment, which is the method of the twenty-sixth embodiment, wherein placing the cementitious composition into at least a portion of the annular space comprises: circulating the cementitious composition down through the conduit and back up through the annular space.

A twenty-eighth embodiment, which is the method of the twenty-sixth embodiment, wherein placing the cementitious composition into at least a portion of the annular space comprises: circulating the cementitious composition down through the annular space and back up through the conduit.

A twenty-ninth embodiment, which is the method of any of the twenty-sixth through the twenty-eighth embodiments, wherein the conduit comprises casing.

A thirtieth embodiment, which is a method of reducing a carbon footprint of a wellbore servicing operation comprising: placing a cementitious composition comprising Portland cement and pozzolan into the wellbore, wherein the Portland cement is present in an amount of from equal to or greater than about 0.01 wt. % to equal to or less than about 25.0 wt. % based on the total weight of the cement blend and wherein the cementitious composition has a carbon footprint of equal to or less than about 150.0 kilograms of equivalent CO₂ per barrel of the cementitious composition (kg/bbl).

A thirty-first embodiment, which is the method of the thirtieth embodiment, wherein the cementitious composition has a thickening time to reach about 70 Bearden units of consistency (Bc) in a range of from about 2.0 hours to about 20.0 hours at about 160° F., when measured in accordance with test standard API-RP-10B-2.

A thirty-second embodiment, which is the method of the thirtieth embodiment, wherein at equal to or less than about 25 wt. % Portland cement the compressive strength and thickening time increases with increasing amounts of Portland cement and at greater than about 25 wt. % Portland cement the compressive strength increases with increasing amounts of Portland cement and the thickening time decreases with increasing amounts of Portland cement.

A thirty-third embodiment, which is the method of the first embodiment, wherein a plot of the compressive strength of the cementitious composition increases monotonically as a function of Portland cement at amounts of Portland cement ranging from about 1 wt. % to about 99 wt. %.

A thirty-fourth embodiment, which is the method of the thirty-third embodiment, wherein a plot of thickening time as a function of Portland cement increases monotonically as the amount of Portland cement increases in a range of Portland cement of equal to or less about 25 wt. % and the thickening time decreases as Portland cement amounts increase to greater than about 25 wt. %.

While embodiments of the disclosure have been shown and described, modifications thereof can be made by one skilled in the art without departing from the spirit and teachings of the disclosure. The embodiments described herein are exemplary only, and are not intended to be limiting. Many variations and modifications of the disclosure disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R_{U}, is disclosed, any number falling within the range is specifically disclosed. In particular, the following numbers within the range are specifically disclosed: R=R_{L}+k*(R_{U}−R_{L}), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. When a feature is described as “optional,” both embodiments with this feature and embodiments without this feature are disclosed. Similarly, the present disclosure contemplates embodiments where this feature is required and embodiments where this feature is specifically excluded. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the embodiments of the present disclosure.

What is claimed is:

1. A method of servicing a wellbore penetrating a subterranean formation, comprising: placing a cementitious composition into the wellbore, wherein the cementitious composition comprises a cement blend and water,
wherein the cement blend comprises Portland cement and pozzolan,
wherein the Portland cement is present in an amount of from equal to or greater than about 0.01 wt. % to equal to or less than about 25.0 wt. % based on the total weight of the cement blend.

2. The method of claim 1, wherein the pozzolan comprises fly ash, natural glass, volcanic glass, volcanic rock, agricultural waste ash, waste ash, ground slag, silica fume, diatomaceous earth, metakaolin, zeolite, calcined clays, shale, pumicite, tuff, cement kiln dust, granite powder, silica sand, glass beads, cenospheres, a vitrified shale, a ground pozzolanic by-product, or combinations thereof.

3. The method of claim 1, wherein the pozzolan is present in the cement blend in an amount of from about 75.0 wt. % to about 99.99 wt. %, based on the total weight of the cement blend.

4. The method of claim 1, wherein the cement blend further comprises gypsum cement, shale cement, acid/base cement, phosphate cement, high alumina content cement, slag cement, silica cement, high alkalinity cement, magnesia cement, other settable materials, or combinations thereof.

5. The method of claim 1, wherein the cement blend is present in the cementitious composition in an amount of from about 0.001 wt. % to about 85.0 wt. % based on the total weight of the cementitious composition.

6. The method of claim 1, wherein the cementitious composition further comprises one or more additives.

7. The method of claim 6, wherein the one or more additives comprise weighting agents, retarders, accelerators, activators, gas control additives, lightweight additives, gas-generating additives, mechanical-property-enhancing additives, lost-circulation materials, filtration-control additives, fluid-loss-control additives, defoaming agents, foaming agents, transition time modifiers, dispersants, thixotropic additives, suspending agents, or combinations thereof.

8. The method of claim 1, wherein a thickening time of the cementitious composition increases monotonically as the amount of the Portland cement increases.

9. The method of claim 1, wherein the cementitious composition has a thickening time to reach about 70 Bearden units of consistency (Bc) in a range of from about 2.0 hours to about 20.0 hours at about 160° F., when measured in accordance with test standard API-RP-10B-2.

10. The method of claim 1, wherein a time to reach 50 psi compressive strength of the cementitious composition increases as the amount of the Portland cement increases, wherein the time to reach 50 psi compressive strength is measured in an ultrasonic cement analyzer (UCA) test in accordance with test standard API-RP-10B-2.

11. The method of claim 1, wherein the cementitious composition has a time to reach 50 psi compressive strength in a range of from about 2.0 hours to about 20.0 hours at about 160° F. in a UCA test, when measured in accordance with test standard API-RP-10B-2.

12. The method of claim 1, wherein the cementitious composition has a UCA compressive strength in a range of from about 50.0 psi to about 10,000.0 psi at about 160° F. between about 24 hours to about 48 hours in a UCA test when measured in accordance with test standard API-RP-10B-2.

13. The method of claim 1, wherein the cementitious composition has a viscosity of from about 3.0 cP to about 2500.0 cP.

14. The method of claim 1, wherein the cementitious composition has a density of from about 4.0 lb/gal to about 25.0 lb/gal.

15. The method of claim 1, wherein the cementitious composition has a carbon footprint of equal to or less than about 150.0 kilograms of equivalent CO₂ per barrel of the cementitious composition (kg/bbl).

16. The method of claim 1, further comprising circulating the cementitious composition down through a conduit and back up through an annular space between an outside wall of the conduit and a wall of the wellbore.

17. The method of claim 1, further comprising circulating the cementitious composition down through an annular space between an outside wall of a conduit and a wall of the wellbore and back up through the conduit.

18. The method of claim 1, further comprising allowing at least a portion of the cementitious composition to set.

19. A method of servicing a wellbore penetrating a subterranean formation, comprising: placing a cementitious composition into the wellbore, wherein the cementitious composition comprises a cement blend and water,
wherein the cement blend comprises Portland cement and pozzolan,
wherein the Portland cement is present in an amount of from equal to or greater than about 0.01 wt. % to equal to or less than about 25.0 wt. % based on the total weight of the cement blend; and
allowing at least a portion of the cementitious composition to set.

20. A method of reducing a carbon footprint of a wellbore servicing operation comprising: placing a cementitious composition comprising Portland cement and pozzolan into the wellbore, wherein the Portland cement is present in an amount of from equal to or greater than about 0.01 wt. % to equal to or less than about 25.0 wt. % based on the total weight of the cement blend and wherein the cementitious composition has a carbon footprint of equal to or less than about 150.0 kilograms of equivalent CO₂ per barrel of the cementitious composition (kg/bbl).

21. The method of claim 19, wherein the cementitious composition has a thickening time to reach about 70 Bearden units of consistency (Bc) in a range of from about 2.0 hours to about 20.0 hours at about 160° F., when measured in accordance with test standard API-RP-10B-2.

22. The method of claim 19, wherein at equal to or less than about 25 wt. % Portland cement the compressive strength and thickening time increases with increasing amounts of Portland cement and at greater than about 25 wt. % Portland cement the compressive strength increases with increasing amounts of Portland cement and the thickening time decreases with increasing amounts of Portland cement.

23. The method of claim 1, wherein a plot of the compressive strength of the cementitious composition increases monotonically as a function of Portland cement at amounts of Portland cement ranging from about 1 wt. % to about 99 wt. %.

24. The method of claim 23, wherein a plot of thickening time as a function of Portland cement increases monotonically as the amount of Portland cement increases in a range of Portland cement of equal to or less about 25 wt. % and the thickening time decreases as Portland cement amounts increase to greater than about 25 wt. %.
